(19) United States
(12) Patent Application Publication
(10) Pub. No.: US 2026/0023340 A1
(43) Pub. Date: Jan. 22, 2026

(54) IMAGE FORMING APPARATUS

(71) Applicant: FUJIFILM Business Innovation Corp., Tokyo (JP)

(72) Inventor: Akira Shimodaira, Kanagawa (JP)

(73) Assignee: FUJIFILM Business Innovation Corp., Tokyo (JP)

(21) Appl. No.: 19/050,917

(22) Filed: Feb. 11, 2025

(30) Foreign Application Priority Data
Jul. 16, 2024 (JP) 2024-113083

(51) Int. Cl. G03G 15/20; G03G 15/00

(52) U.S. Cl. CPC G03G 15/2039; G03G 15/2064; G03G 15/5029; G03G 15/657; G03G 2215/00413; G03G 2215/0062; G03G 2215/00738

(57) ABSTRACT

An image forming apparatus includes a fixing member that includes a heater that generates heat in accordance with a predetermined fixing temperature to fix an unfixed image held on a medium, a bend detector that is disposed upstream from the fixing member in a medium transport direction to detect a bend of a medium having a leading end arriving at the fixing member, and a heating control member that controls the heater based on the bend of the medium detected by the bend detector.

### CROSS-REFERENCE TO RELATED APPLICATIONS

This application is based on and claims priority under 35 USC 119 from Japanese Patent Application No. 2024-113083 filed Jul. 16, 2024.

### BACKGROUND

### (i) Technical Field

The present disclosure relates to an image forming apparatus.

### (ii) Related Art

Technologies relating to an image forming apparatus that detects the type of medium on which images are recorded are described in Japanese Unexamined Patent Application Publication Nos. 2019-12174 ([0049] to [0087]), 2019-184778 ([0046] to [0078]), and 2007-199343 ([0054] to [0061]).

Japanese Unexamined Patent Application Publication No. 2019-12174 describes a technology of a medium sensor (40) that is disposed upstream from a transfer area and that detects the basis weight of a recording medium (P) with light reflected from the recording medium (P) and controls a fixing temperature. In Japanese Unexamined Patent Application Publication No. 2019-12174, two heating devices are included as fixing devices, and either one of the heating devices is selected to be used in accordance with the basis weight to reduce the difference in gloss level.

Japanese Unexamined Patent Application Publication No. 2019-184778 describes a technology of a medium sensor (16) that is disposed upstream from a transfer area and that determines the basis weight of a paper sheet (P) with light reflected from the paper sheet (P), and determines fixing conditions. Japanese Unexamined Patent Application Publication No. 2019-184778 also describes correction of the basis weight detected by the medium sensor (16) with thermal conductivity or the thickness of the paper sheet (P).

Japanese Unexamined Patent Application Publication No. 2007-199343 describes a technology of determining the type of recording medium, including the basis weight of the recording medium, based on an area coverage of the recording medium and the speed at which the recording medium is transported immediately after entering a fixing nip of a fixing device. The device in Japanese Unexamined Patent Application Publication No. 2007-199343 performs a control to transport a recording paper sheet passing the fixing nip at a target speed.

### SUMMARY

Aspects of non-limiting embodiments of the present disclosure relate to a further reduction in fixing errors while reducing costs compared to a case where a fixing temperature is controlled by using a component that presumes the type of medium based on reflectance from the medium or transmittance of the medium.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an image forming apparatus according to an aspect of the present disclosure that includes a fixing member that includes a heater that generates heat in accordance with a predetermined fixing temperature to fix an unfixed image held on a medium, a bend detector that is disposed upstream from the fixing member in a medium transport direction to detect a bend of a medium having a leading end arriving at the fixing member, and a heating control member that controls the heater based on the bend of the medium detected by the bend detector.

### BRIEF DESCRIPTION OF THE DRAWINGS

Exemplary embodiments of the present disclosure will be described in detail based on the following figures, wherein:

FIG. 1 is a diagram of the entirety of an image forming apparatus according to a first example;

FIG. 2 is a diagram of a related portion of an image recording portion according to a first example;

FIG. 3 is a diagram of a related portion ranging from a transfer area to a fixing area in a first example;

FIG. 4 is a perspective view of a guide member including a bend detector;

FIGS. 5A, 5B, and 5C are diagrams of a bend detector according to a first example, where FIG. 5A is a diagram of the bend detector that is not in contact with a medium, FIG. 5B is a diagram of the bend detector with which a medium with a small bend is in contact, and FIG. 5C is a diagram of the bend detector with which a medium with a large bend is in contact;

FIGS. 6A, 6B, and 6C are diagrams illustrating timing of detection of a bend of a medium according to the first example, where FIG. 6A is a diagram of a fixing device at which the leading end of a medium has not arrived yet, FIG. 6B is a diagram of the fixing device at which the leading end of an ordinary paper sheet has arrived, and FIG. 6C is a diagram of the fixing device at which the leading end of a thick paper sheet has arrived; and

FIG. 7 is a graph illustrating the relationship between the basis weight of a paper sheet and the degree of bending.

### DETAILED DESCRIPTION

With reference now to the drawings, examples serving as specific examples of exemplary embodiments of the present disclosure are described, but the present disclosure is not limited to the exemplary embodiments described below.

For easy understanding of the description below, throughout the drawings, an X-axis direction denotes the front-rear direction, a Y-axis direction denotes the lateral direction, and a Z-axis direction denotes the vertical direction. The directions or sides indicated by arrows X, −X, Y, −Y, Z, and −Z are respectively referred to as forward, rearward, rightward, leftward, upward, and downward, or a front side, a rear side, a right side, a left side, an upper side, and a lower side.

Throughout the drawings, an encircled dot denotes an arrow directing from the back to the front of the sheet, and an encircled cross denotes an arrow directing from the front to the back of the sheet.

In the description with reference to the drawings, components other than those needed for the description are appropriately omitted for ease of understanding.

### First Exemplary Embodiment

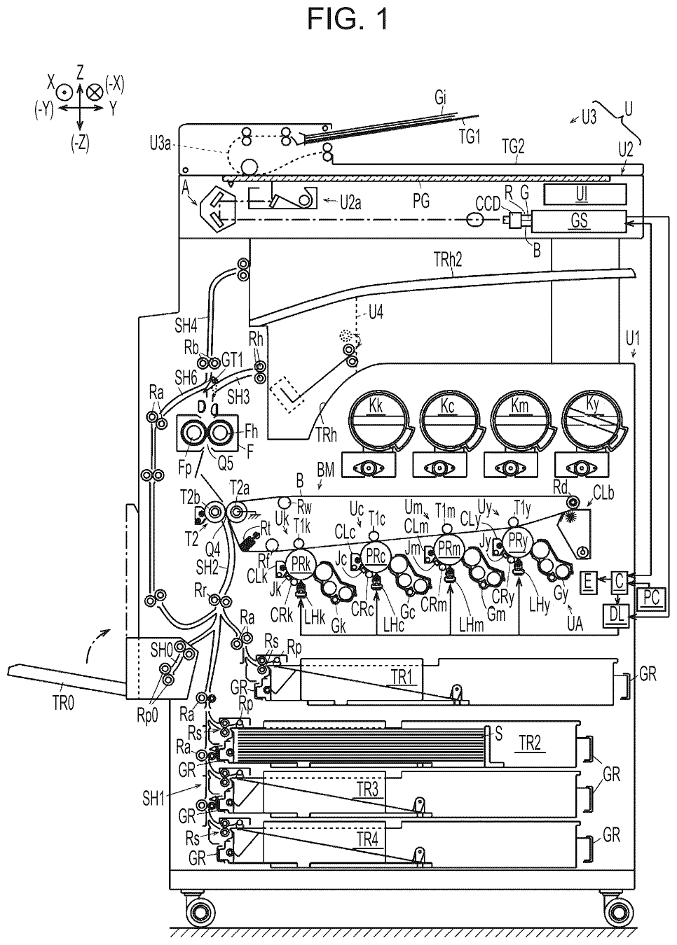

FIG. 1 illustrates the entirety of an image forming apparatus according to a first example.

In FIG. 1, a copying machine U serving as an example of the image forming apparatus according to the first example of the present disclosure includes a printer portion U1, serving as an example of an image recorder and an example of an image recording device. The printer portion U1 supports, at an upper portion, a scanner portion U2, serving as an example of a reading unit and an example of an image reading device. The scanner portion U2 supports, at an upper portion, an auto-feeder U3 serving as an example of a medium transporting device.

Above the auto-feeder U3, a document tray TG1, serving as an example of a medium container, is disposed. The document tray TG1 is capable of receiving a stack of multiple documents Gi that are to be copied. Below the document tray TG1, a document exit tray TG2 serving as an example of a document exit portion is disposed. Between the document tray TG1 and the document exit tray TG2, document transport rollers are disposed along a document transport path U3a.

At the upper surface of the scanner portion U2, a platen glass PG serving as an example of a transparent document table is disposed. The scanner portion U2 according to the first example includes a light source unit U2a, which serves as an example of a light source and is disposed below the platen glass PG. The light source unit U2a according to the first example is supported to be movable in a lateral direction, serving as an example of a sub-scanning direction, along the lower surface of the platen glass PG. Light emitted from the light source unit U2a and reflected off each document Gi is reflected by an optical system A, and incident on a reading device charge coupled device (CCD). Light that is incident on the reading device CCD is converted into signals R, G, and B, and input into an image processor GS.

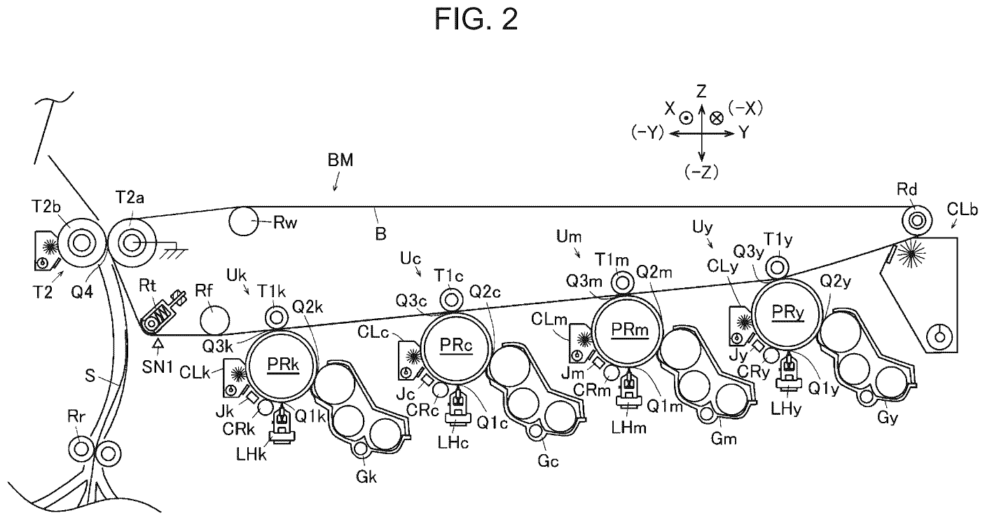

FIG. 2 is a diagram illustrating a related portion of an image recording portion according to the first example.

The image processor GS is electrically connected to a write circuit DL in the printer portion U1. The write circuit DL is electrically connected to light exposure devices LHy, LHm, LHc, and LHk serving as examples of image forming members.

The light exposure devices LHy to LHk according to the first example each include a light emitting diode (LED) head including multiple LEDs, serving as examples of light emitting devices, arranged on the substrate in a main scanning direction. The light exposure devices LHy to LHk are capable of outputting write light beams corresponding to colors of yellow (Y), magenta (M), cyan (C), and black (K) in accordance with signals input from a write circuit DL.

The write circuit DL or a power source circuit E are controlled in terms of write timing or power supply timing in accordance with control signals from a controller C serving as an example of a control member.

In FIG. 1, above the light exposure devices LHy to LHk, photoconductors PRy, PRm, PRc, and PRk serving as examples of image carriers are disposed. In FIG. 1 and FIG. 2, the areas of the photoconductors PRy to PRk irradiated with write light constitute write areas Q1y, Q1m, Q1c, and Q1k.

Upstream from the write areas Q1y to Q1k in rotation directions of the photoconductors PRy to PRk, charging rollers CRy, CRm, CRc, and CRk serving as examples of chargers are respectively disposed. The charging rollers CRy to CRk according to the first example are supported to be rotatably driven while being in contact with the photoconductors PRy to PRk.

Downstream from the write areas Q1y to Q1k in the rotation directions of the photoconductors PRy to PRk, developing devices Gy, Gm, Gc, and Gk serving as examples of developing members are respectively disposed. Areas where the photoconductors PRy to PRk and the developing devices Gy to Gk respectively face one another constitute development areas Q2y, Q2m, Q2c, and Q2k.

Downstream from the developing devices Gy to Gk in the rotation directions of the photoconductors PRy to PRk, first transfer rollers T1y, T1m, T1c, and T1k serving as examples of first transfer members are respectively disposed. Areas where the photoconductors PRy to PRk and the first transfer rollers T1y to T1k respectively face one another constitute first transfer areas Q3y, Q3m, Q3c, and Q3k.

Downstream from the first transfer rollers T1y to T1k in the rotation directions of the photoconductors PRy to PRk, photoconductor cleaners CLy, CLm, CLc, and CLk serving as examples of cleaners are respectively disposed.

Downstream from the photoconductor cleaners CLy to CLK in the rotation directions of the photoconductors PRy to PRk, static eliminators Jy, Jm, Jc, and Jk serving as examples of static eliminating members or examples of static eliminating devices are respectively disposed.

The photoconductor PRy, the charging roller CRy, the light exposure device LHy, the developing device Gy, the first transfer roller T1y, the photoconductor cleaner CLy, and the static eliminator Jy for the color Y constitute an image forming portion Uy for the color Y serving as an example of a visible image forming member for the color Y according to the first example that forms toner images of the color Y. Similarly, each of the photoconductors PRm, PRc, and PRk, the corresponding one of the charging rollers CRm, CRc, and CRk, the corresponding one of the light exposure devices LHm, LHc, and LHk, the corresponding one of the developing devices Gm, Gc, and Gk, the corresponding one of the first transfer rollers T1m, T1c, and T1k, the corresponding one of the photoconductor cleaners CLm, CLc, and CLK, and the corresponding one of the static eliminators Jm, Jc, and Jk constitute an image forming portion Um, Uc, or Uk for the corresponding one of the colors M, C, and K.

Above the photoconductors PRy to PRk, a belt module BM serving as an example of an intermediate transfer device is disposed. The belt module BM includes an intermediate transfer belt B serving as an example of an image carrier and an example of an intermediate transfer member. The intermediate transfer belt B is formed from an endless belt.

The intermediate transfer belt B according to the first example is rotatably supported by a tension roller Rt serving as an example of a tensioner, a walking roller Rw serving as an example of an imbalance corrector, an idler roller Rf serving as an example of a driven member, a backup roller T2a serving as an example of an opposing member opposing a second transfer area, the first transfer rollers T1y to T1k, and a driving roller Rd serving as an example of a driving member. In the first example, when a driving force is transmitted to the driving roller Rd, the intermediate transfer belt B rotates.

Downstream from the first transfer rollers T1y to T1k and between the first transfer rollers T1y to T1k and the backup roller T2a, an image detection sensor SN1 serving as an example of a detector is disposed to face the surface of the intermediate transfer belt B to detect an image on the intermediate transfer belt B.

At a position facing the backup roller T2a across the intermediate transfer belt B, a second transfer roller T2b serving as an example of a transfer member and an example of a second transfer member is disposed. Components including the backup roller T2a and the second transfer roller T2b constitute a second transfer device T2 according to the first example serving as an example of a transfer device. The area where the second transfer roller T2b and the intermediate transfer belt B are in contact constitutes a second transfer area Q4.

The second transfer roller T2b according to the first example is movable between a contact position, at which the second transfer roller T2b comes into contact with the intermediate transfer belt B, and a separate position, at which the second transfer roller T2b is spaced apart from the intermediate transfer belt B.

Downstream from the second transfer area Q4 in the rotation direction of the intermediate transfer belt B, a belt cleaner CLb is disposed as an example of a cleaning device to clean the intermediate transfer body.

Components including the first transfer rollers T1y to T1k, the intermediate transfer belt B, and the second transfer device T2 constitute a transfer device T1+T2+B according to the first example. The image forming portions Uy to Uk and the transfer device T1+T2+B constitute an image recording portion Uy−Uk+T1+T2+B according to the first example.

In FIG. 1, below the image forming portions Uy to Uk, four pairs of left and right guide rails GR serving as examples of guide members are disposed. On the guide rails GR, sheet feeding trays TR1, TR2, TR3, and TR4 serving as examples of medium containers are supported to be movable in and out in a front-rear direction. The sheet feeding trays TR1 to TR4 receive recording paper sheets S serving as examples of media.

At the upper left of each of the sheet feeding trays TR1 to TR4, a pickup roller Rp serving as an example of a pickup member is disposed. Downstream from the pickup roller Rp in the transport direction of the recording paper sheet S, separation rollers Rs serving as examples of separators are disposed. Downstream from the separation rollers Rs in the transport direction of the recording paper sheet S, a sheet feeding path SH1 extending upward is disposed as an example of a medium transport path. Multiple transport rollers Ra serving as examples of transport members are disposed on the sheet feeding path SH1.

At a lower left of the copying machine U, a manual feed tray TR0 serving as an example of a medium container is disposed. At an upper right of the manual feed tray TR0, pickup rollers Rp0 are disposed, and a manual sheet feeding path SH0 extends. The manual sheet feeding path SH0 merges into the sheet feeding path SH1.

On the sheet feeding path SH1, upstream from the second transfer area Q4, registration rollers Rr serving as examples of adjusters of a transport timing are disposed. A transport path SH2 extends from the registration rollers Rr toward the second transfer area Q4.

Downstream from the second transfer area Q4 in the transport direction of the recording paper sheet S, a fixing device F serving as an example of a fixing member is disposed. The fixing device F includes a heating roller Fh serving as an example of a fixing member for heating, and a pressing roller Fp serving as an example of a fixing member for pressing. A contact area where the heating roller Fh and the pressing roller Fp are in contact constitutes a fixing area Q5.

At an upper surface of the printer portion U1, a lower paper exit tray TRh serving as an example of a medium exit portion is disposed. In the first example, at the lower paper exit tray TRh, a finisher U4 serving as an example of a postprocessing device is disposed. Above the fixing device F, a sheet exit path SH3 serving as an example of a transport path extends toward the lower paper exit tray TRh. At the downstream end of the sheet exit path SH3, discharging rollers Rh serving as examples of medium transporting members are disposed.

Above the lower paper exit tray TRh, an upper paper exit tray TRh2 serving as an example of a medium exit portion is disposed. Above the fixing device F, an upper transport path SH4 that diverges from the sheet exit path SH3 to extend toward the upper paper exit tray TRh2 is disposed.

On the upper transport path SH4, reverse rollers Rb serving as examples of medium transporting members rotatable forward and backward are disposed. Above a position where the sheet exit path SH3 and the upper transport path SH4 diverge, a reverse path SH6 serving as an example of a medium transport path diverges to the lower left from the upper transport path SH4.

A gate GT1 serving as an example of a switching member is disposed across a diverging portion at which the sheet exit path SH3 and the upper transport path SH4 diverge and a diverging portion at which the upper transport path SH4 and the reverse path SH6 diverge. The gate GT1 is supported to be switchable between a first guide position (a second position) to guide the recording paper sheet S from the fixing device F toward the lower paper exit tray TRh, and to guide the recording paper sheet S from the upper transport path SH4 to the reverse path SH6, and a second guide position (a first position) to guide the recording paper sheet S from the fixing device F toward the upper transport path SH4.

The multiple transport rollers Ra are disposed on the reverse path SH6. The downstream end of the reverse path SH6 merges into the sheet feeding path SH1 upstream from the registration rollers Rr.

### Description of Image Forming Operation

When an operator manually places a document Gi on the platen glass PG to perform copying with the copying machine U according to the first example with the above structure, the light source unit U2a moves in the lateral direction from the initial position to scan the document Gi on the platen glass PG while exposing the document Gi with light.

When the auto-feeder U3 is used and a copying start key is input, documents Gi are automatically transported. When the copying start key is input, the multiple documents Gi received on the document tray TG1 are sequentially transported to and pass a document read position on the platen glass PG. The documents Gi sequentially passing the read position on the platen glass PG are irradiated by the light source unit U2a with light. The documents Gi that have passed the read position are discharged to the document exit tray TG2. Reflection light reflected off the documents Gi is converted into electric signals by the reading device CCD.

The image processor GS receives an input of electric signals output from the reading device CCD. The image processor GS converts the electric signals of images of the colors R, G, and B read by the reading device CCD into image information of yellow (Y), magenta (M), cyan (C), and black (K) for forming latent images. The image processor GS outputs the image information obtained after the conversion to the write circuit DL in the printer portion U1. To form a single-color image or a monochrome image as the image, the image processor GS outputs the image information of only black (K) to the write circuit DL.

The write circuit DL outputs control signals corresponding to the input image information to the light exposure devices LHy to LHk. The light exposure devices LHy to LHk output write light corresponding to the control signals.

Each of the photoconductors PRy to PRk is driven to rotate when the image formation is started. A charging voltage is applied to the charging rollers CRy to CRk from the power source circuit E. The surfaces of the photoconductors PRy to PRk are thus electrically charged by the charging rollers CRy to CRk. In the write areas Q1y to Q1k on the surfaces of the electrically charged photoconductors PRy to PRk, electrostatic latent images are formed by write light from the light exposure devices LHy to LHk. The electrostatic latent images on the photoconductors PRy to PRk are developed into toner images, serving as examples of images, by the developing devices Gy to Gk in the development areas Q2y to Q2k.

The developed toner images pass the first transfer areas Q3y to Q3k. A first transfer voltage with a polarity opposite to the charging polarity of toner is applied from the power source circuit E to the first transfer rollers T1y to T1k. The toner images on the photoconductors PRy to PRk are thus transferred to the intermediate transfer belt B by the first transfer rollers T1y to T1k. To form a multi-color toner image, a toner image on the downstream side is transferred, in a superposed manner, onto a toner image that has been transferred to the intermediate transfer belt B in the upstream first transfer area.

Remnants or accretions on the photoconductors PRy to PRk that have undergone first transfer are removed by the photoconductor cleaners CLy to CLk. The surfaces of the cleaned photoconductors PRy to PRk undergo static elimination by the static eliminators Jy to Jk. The surfaces of the photoconductors PRy to PRk that have undergone static elimination are charged again by the charging rollers CRy to CRk.

The single-color or multi-color toner image transferred onto the intermediate transfer belt B in the first transfer areas Q3y to Q3k is transported to the second transfer area Q4.

The recording paper sheet S on which an image is to be recorded is picked up by any of the pickup rollers Rp at the sheet feeding trays TR1 to TR4 to be used. When multiple recording paper sheets S are collectively picked up by the pickup roller Rp in a stacked manner, the multiple recording paper sheets S are separated one by one by the separation rollers Rs. The recording paper sheets S separated by the separation rollers Rs are transported by the transport rollers Ra along the sheet feeding path SH1. The recording paper sheets S transported along the sheet feeding path SH1 are transported to the registration rollers Rr. The recording paper sheets S loaded on the manual feed tray TR0 are also transported to the sheet feeding path SH1 through the manual sheet feeding path SH0 by the pickup rollers Rp0.

The registration rollers Rr transports the recording paper sheet S to the second transfer area Q4 at the timing when the toner image formed on the intermediate transfer belt B is transported to the second transfer area Q4. A second transfer voltage having a polarity opposite to the charging polarity of the toner is applied to the second transfer roller T2b by the power source circuit E. The toner image on the intermediate transfer belt B is thus transferred to the recording paper sheet S from the intermediate transfer belt B.

Accretions or other matter adhering to the surface of the intermediate transfer belt B that has undergone second transfer are removed by the belt cleaner CLb.

The recording paper sheet S to which the toner image is second transferred undergoes fixing with heat when passing the fixing area Q5.

When the recording paper sheet S to which an image is fixed is to undergo postprocessing, the recording paper sheet S is transported to the finisher U4 disposed at the lower paper exit tray TRh. When the recording paper sheet S is not to undergo postprocessing, the recording paper sheet S is transported to the upper paper exit tray TRh2. To transport the recording paper sheet S to the lower paper exit tray TRh, the gate GT1 moves to the first guide position. Thus, the recording paper sheet S fed from the fixing device F is transported along the sheet exit path SH3. The recording paper sheet S transported along the sheet exit path SH3 is transported by the discharging rollers Rh toward the finisher U4 and the lower paper exit tray TRh.

After performing a binding process, serving as an example of postprocessing, on the recording paper sheet S, the finisher U4 discharges the recording paper sheet S to the lower paper exit tray TRh.

To discharge the recording paper sheet S to the upper paper exit tray TRh2, the gate GT1 moves to the second guide position to discharge the recording paper sheet S to the upper paper exit tray TRh2.

To perform two-side printing on the recording paper sheet S, the gate GT1 moves to the second guide position. When the trailing end of the recording paper sheet S passes the gate GT1, the gate GT1 moves to the first guide position, and the reverse roller Rb rotates in the reverse direction. Thus, the recording paper sheet S is guided by the gate GT1 to be transported to the reverse path SH6. The recording paper sheet S transported along the reverse path SH6 is transported to the registration rollers Rr while being turned upside down.

### (Description of Bend Detector)

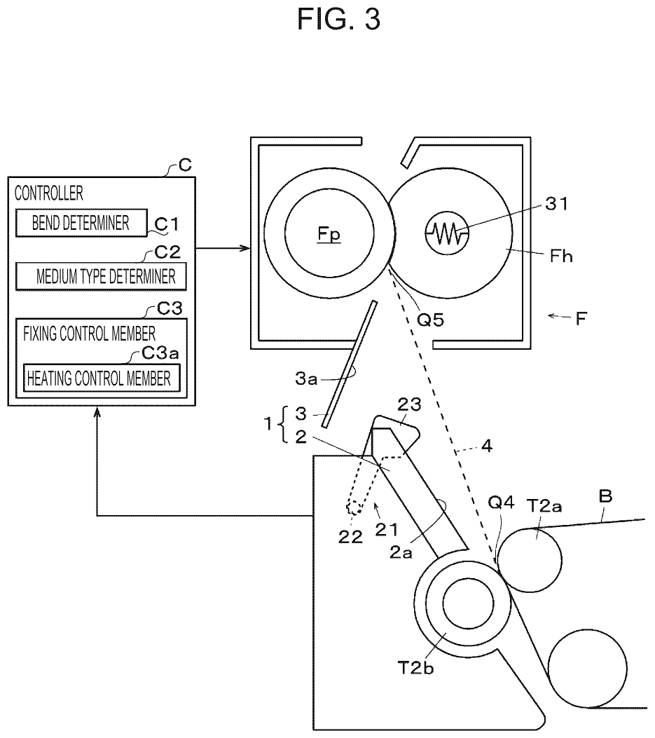

FIG. 3 is a diagram of a related portion ranging from a transfer area to a fixing area according to the first example.

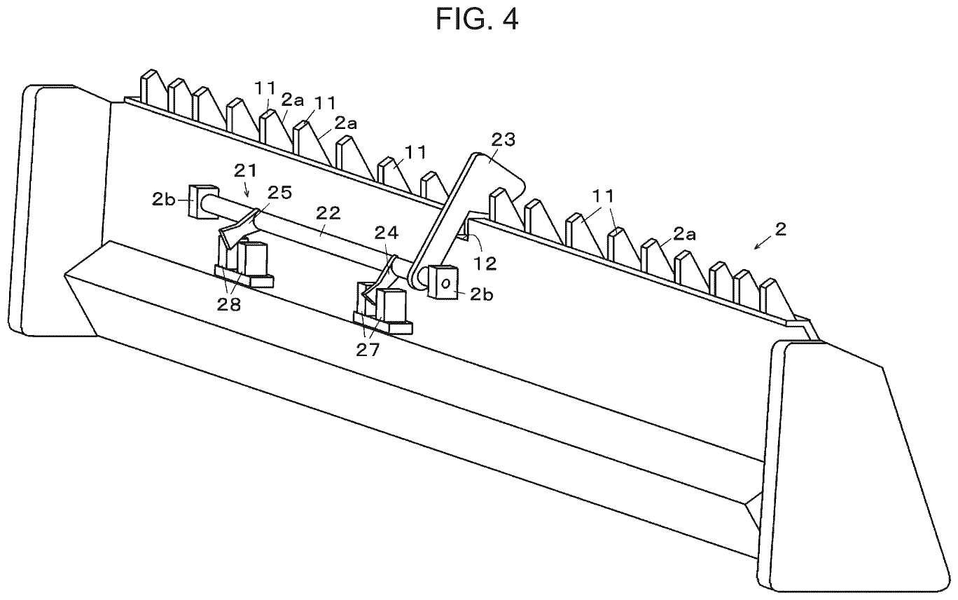

FIG. 4 is a perspective view of a guide member including a bend detector.

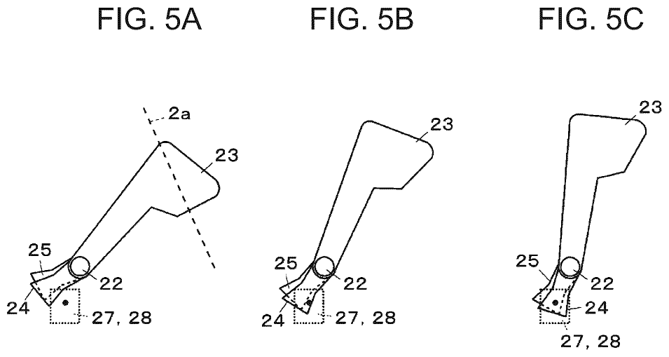

FIGS. 5A, 5B, and 5C are diagrams of a bend detector according to the first example, where FIG. 5A is a diagram of the bend detector that is not in contact with a medium, FIG. 5B is a diagram of the bend detector with which a medium with a small bend is in contact, and FIG. 5C is a diagram of the bend detector with which a medium with a large bend is in contact.

In FIG. 3, between the second transfer area Q4 and the fixing area Q5, a paper sheet guide 1 serving as an example of a guide member is disposed. The paper sheet guide 1 includes a post-transfer guide 2 serving as an example of a first guide portion, and an inlet chute 3 serving as an example of a second guide portion. The post-transfer guide 2 is disposed downstream from the second transfer area Q4 in the paper sheet transport direction. The inlet chute 3 is disposed downstream from the post-transfer guide 2 and upstream from the fixing area Q5. The recording paper sheet S that has passed the second transfer area Q4 is guided by the post-transfer guide 2 and the inlet chute 3, and transported to the fixing area Q5. The post-transfer guide 2 and the inlet chute 3 are in contact with the surface (back surface) of the recording paper sheet S opposite to the surface to which the unfixed image is transferred.

The post-transfer guide 2 according to the first example has a guide surface 2a on the surface that extends to be spaced farther from an imaginary line 4, connecting the second transfer area Q4 and the fixing area Q5, or toward the back surface as it extends further downstream in the paper sheet transport direction. The imaginary line 4 is an imaginary line connecting the downstream side, serving as an exit of the second transfer area Q4, of the second transfer device T2 serving as an example of a transporting member and the upstream side, serving as an inlet of the fixing area Q5, of the rollers Fh and Fp of the fixing device F.

The inlet chute 3 has a guide surface 3a on the surface that extends to be located closer to the imaginary line 4, connecting the second transfer area Q4 and the fixing area Q5, as it extends further downstream in the paper sheet transport direction.

The recording paper sheet S is thus likely to be guided by the post-transfer guide 2 and the inlet chute 3 while being bent to swell backward in the range from the second transfer area Q4 to the fixing area Q5.

The post-transfer guide 2 includes multiple guide portions 11 having a rib shape. The multiple guide portions 11 are arranged at intervals in the width direction of the recording paper sheet S.

The post-transfer guide 2 includes an actuator 21, serving as an example of a movable member, disposed on the side (inner side) opposite to the guide surface 2a (outer side). The actuator 21 is disposed between the second transfer area Q4 and the fixing area Q5 in the paper sheet transport direction. The actuator 21 is supported by bearing portions 2b of the post-transfer guide 2 to be rotatable about a rotation shaft 22.

The actuator 21 includes a contact portion 23 extending in the radial direction from the rotation shaft 22. The contact portion 23 passes a cut portion 12 serving as an example of a transit portion formed in the post-transfer guide 2, and extends into the transport path for the recording paper sheet S. The contact portion 23 is disposed between the guide portions 11 in the paper sheet width direction.

Thus, in FIG. 5A, the outer end of the contact portion 23 is disposed closer to the imaginary line 4 than the guide surfaces 2a of the guide portions 11 when the recording paper sheet S is not in contact with the contact portion 23. The contact portion 23 is thus capable of coming into contact with the recording paper sheet S transported along the transport path.

In FIG. 4, the rotation shaft 22 extends in the width direction of the recording paper sheet S. A small loop shield 24 serving as an example of a first detectable portion is supported on the rotation shaft 22 at a position shifted from the position of the contact portion 23 in the axial direction (paper sheet width direction). A large loop shield 25 serving as an example of a second detectable portion is also supported on the rotation shaft 22 at a position shifted from the positions of the contact portion 23 and the small loop shield 24 in the axial direction (paper sheet width direction).

In FIGS. 4, 5A, 5B, and 5C, the small loop shield 24 and the large loop shield 25 are disposed on the rotation shaft 22 at angular positions displaced in the circumferential direction (rotation direction) of the rotation shaft 22.

Below the rotation shaft 22, a small loop sensor portion 27 serving as an example of a small bend detection portion and a large loop sensor portion 28 serving as an example of a large bend detection portion are disposed.

The small loop sensor portion 27 is disposed at a position corresponding to the small loop shield 24. The small loop sensor portion 27 includes a light emitting portion and a light receiving portion disposed on both sides of the small loop shield 24, and is capable of detecting light from the light emitting portion that is blocked or not blocked by the small loop shield 24.

The large loop sensor portion 28 is disposed at a position corresponding to the large loop shield 25. The large loop sensor portion 28 includes a light emitting portion and a light receiving portion disposed on both sides of the large loop shield 25, and is capable of detecting light from the light emitting portion that is blocked or not blocked by the large loop shield 25.

The actuator 21 rotates about the rotation shaft 22 when the contact portion 23 comes into contact with the recording paper sheet S. In accordance with the degree of the bend of the recording paper sheet S with which the contact portion 23 comes into contact, the actuator 21 rotates about the rotation shaft 22 by different rotation angles. When the recording paper sheet S has a small bend and the actuator 21 rotates by a small rotation angle, as illustrated in FIG. 5B, the actuator 21 moves to a small loop detection position where the small loop shield 24 blocks light from the small loop sensor portion 27 and the large loop shield 25 does not block light from the large loop sensor portion 28. When the recording paper sheet S has a large bend and the actuator 21 rotates by a large rotation angle, as illustrated in FIG. 5C, the actuator 21 moves to a large loop detection position where the small loop shield 24 blocks light from the small loop sensor portion 27 and the large loop shield 25 also blocks light from the large loop sensor portion 28.

Thus, the actuator 21 according to the first example is movable between a non-contact position illustrated in FIG. 5A, the small loop detection position illustrated in FIG. 5B, and the large loop detection position illustrated in FIG. 5C. Depending on the degree of a bend (a small loop or a large loop) intended to be detected, the positions (angular positions) of the small loop shield 24 and the large loop shield 25 on the rotation shaft 22 in the circumferential direction are set.

The actuator 21 according to the first example includes a torsion spring not illustrated attached to the rotation shaft 22 as an example of a return member. The torsion spring exerts an elastic force to move the actuator 21 to a non-contact position in the state where no external force acts on the actuator 21. Thus, the actuator 21 is set to automatically return to the non-contact position when the recording paper sheet S is not in contact with the actuator 21. The torsion spring may be eliminated when the size or the position of the contact portion 23 or each of the shields 24 and 25 is adjusted to allow the actuator 21 to naturally return to the non-contact position with the weight and the center of gravity of the entire actuator 21.

The small loop sensor portion 27 and the large loop sensor portion 28 constitute a sensor portion 27+28 serving as an example of a detector according to the first example. The actuator 21 and the sensor portion 27+28 constitute a loop sensor 21-28 serving as an example of a bend detector.

### Functions of Controller C

In FIG. 3, the copying machine U is controlled by the controller C serving as an example of a control member. The controller C includes an input-output interface I/O for, for example, inputs or outputs of signals from the external devices. The controller C includes a read only memory ROM that stores, for example, programs and information for performing intended processes. The controller C further includes a random access memory RAM that temporarily stores intended data. The controller C further includes a central processing unit CPU that performs processes in accordance with the programs stored in, for example, the ROM. The controller C according to the first example is thus formed by a small-sized information processing device, that is, a microcomputer. The controller C is thus capable of implementing various functions by executing the programs stored in, for example, the ROM.

Hereafter, the controller C according to the first example is described only with regard to the aspects relating to the present disclosure, and the aspects not relating to the present disclosure are neither described nor illustrated.

The controller C according to the first example has functional members (functional modules or program modules) C1 to C3 described below.

A bend determiner C1 determines the degree of a bend based on the measurement results of the loop sensor 21-28. When only the small loop sensor portion 27 detects the small loop shield 24, the bend determiner C1 according to the first example determines that the bend (a loop) is small. When the small loop sensor portion 27 and the large loop sensor portion 28 respectively detect the small loop shield 24 and the large loop shield 25, the bend determiner C1 according to the first example determines that the bend (a loop) is large.

The bend determiner C1 according to the first example detects a bend of the recording paper sheet S having the leading end arriving at the fixing area Q5. In the first example, the bend determiner C1 detects a bend 50 ms after predicted arrival timing instead of immediately after the timing when the leading end of the recording paper sheet S arrives at the fixing area Q5 (predicted arrival timing). This timing of, for example, 50 ms after the predicted arrival timing is set by considering an allowance or a margin for the individual differences in size of the recording paper sheets S or errors in transport speed in the real structures. In accordance with, for example, the design or specifications, the numerical value of 50 ms may be changed as appropriate.

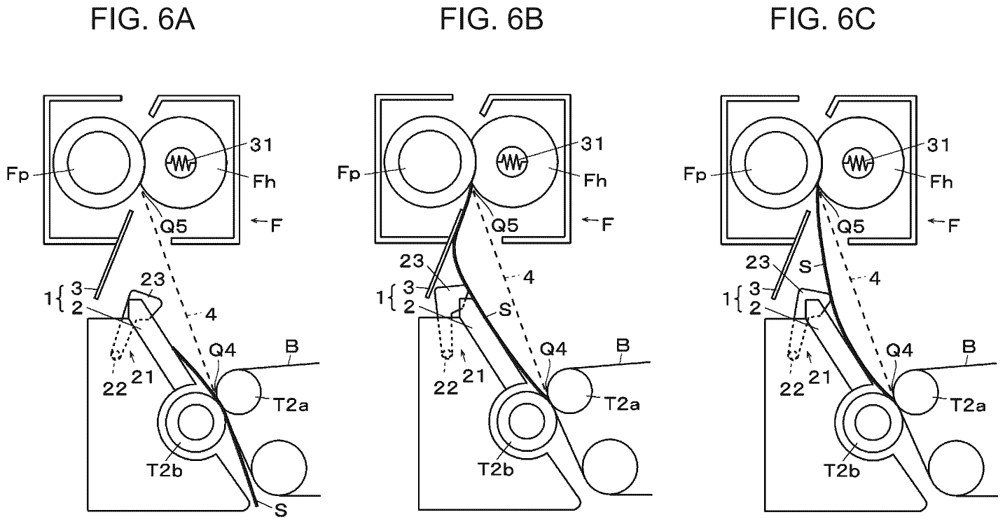

FIGS. 6A, 6B, and 6C are diagrams illustrating detection timing of a bend of a medium according to the first example, where FIG. 6A is a diagram of a fixing device at which the leading end of a medium has not arrived yet, FIG. 6B is a diagram of the fixing device at which the leading end of an ordinary paper sheet has arrived, and FIG. 6C is a diagram of the fixing device at which the leading end of a thick paper sheet has arrived.

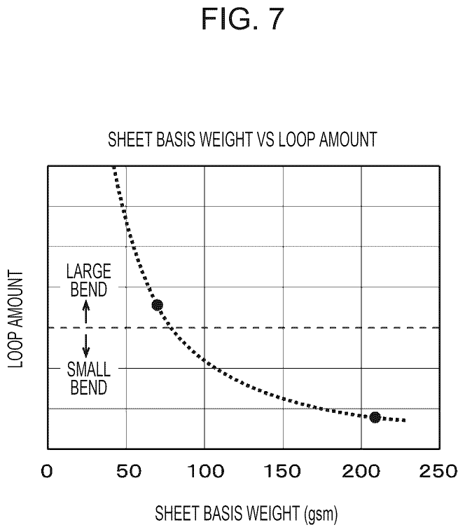

FIG. 7 is a graph illustrating the relationship between the basis weight of a paper sheet and the degree of bending.

In FIG. 6A, after the leading end of the recording paper sheet S passes the second transfer area Q4, the recording paper sheet S is transported downstream along the post-transfer guide 2, and comes into contact with the actuator 21. At this time, the bend determiner C1 is capable of detecting that the leading end of the recording paper sheet S has passed the position of the actuator 21. Regardless of the type or the basis weight of the recording paper sheet S, when the detection result of the loop sensor 21-28 is changed from the non-contact position to either the small loop detection position or the large loop detection position, the bend determiner C1 is capable of detecting that the leading end of the recording paper sheet S has passed the position of the actuator 21.

After the leading end of the recording paper sheet S has passed the position of the actuator 21, the bend determiner C1 determines the degree of a bend in accordance with the timing when the leading end of the recording paper sheet S arrives at the fixing area Q5 based on the transport speed of the recording paper sheet S. In the first example, the bend determiner C1 detects the bend 50 ms after the predicted arrival timing. Although varying with, for example, differences of the transport speed or the size or the shape of the medium, this timing roughly corresponds to the position approximately 10 to 20 mm from the leading end of the recording paper sheet S.

As illustrated in FIG. 6C and FIG. 7, when, a recording paper sheet S with high paper stiffness (a stiff paper sheet) such as a thick paper sheet with a large basis weight or a coated paper sheet or an overhead projector (OHP) sheet is used as a type of medium, the leading end of the recording paper sheet S is likely to arrive at the fixing area Q5 with a small bend as illustrated in FIG. 6C. Thus, when, as illustrated in FIG. 6C, the degree of bending of the recording paper sheet S reaches a small degree of bending to rotate the actuator 21 to the small bend position, the bend determiner C1 determines that the recording paper sheet S has a small bend.

As illustrated in FIG. 6B and FIG. 7, when a recording paper sheet S with a small basis weight and small paper stiffness (a paper sheet with weak stiffness) such as a thin paper sheet or an ordinary paper sheet is used as a type of medium, the leading end of the recording paper sheet S is more likely to arrive at the fixing area Q5 with a large bend following the post-transfer guide 2 and the inlet chute 3, as illustrated in FIG. 6B. Thus, when the degree of bending of the recording paper sheet S is large enough to reach a large degree of bending to rotate the actuator 21 to a large bend position beyond the small bend position, the bend determiner C1 determines that the recording paper sheet S has a large bend.

As illustrated in FIG. 6B and FIG. 6C, in the copying machine U according to the first example, for example, when an ordinary paper sheet is used as a type of medium, the ordinary paper sheet is more likely to be bent while being spaced fully apart from the imaginary line 4, and when a thick paper sheet is used as a type of medium, the thick paper sheet is more likely to be bent while being located closer to the imaginary line 4.

When an image is formed on multiple recording paper sheets S in a single image forming operation (job), the bend determiner C1 according to the first example detects a bend of the first recording paper sheet S, and uses the determination result of the bend of the first recording paper sheet S for the following recording paper sheets S while regarding the following recording paper sheets S as having the same bend. The detection of the bend may be performed on all the recording paper sheets S, or may be periodically performed on, for example, every ten sheets.

A medium type determiner C2 determines the type (medium type) of the recording paper sheet S. The medium type determiner C2 determines the type of medium of the used recording paper sheet S based on the type of medium input with the user interface U1 or the type of medium preliminarily registered with the sheet feeding trays TR1 to TR4. The medium type determiner C2 then determines whether the type of medium is consistent based on the determination result of the bend determiner C1 after the transportation of the recording paper sheet S. When, for example, the type of medium registered with the sheet feeding trays TR1 to TR4 is an ordinary paper sheet, and the determination result of the bend determiner C1 is a small bend, the medium type determiner C2 determines that the type of medium is inconsistent. In this case, the medium type determiner C2 according to the first example preferentially uses the determination result of the bend determiner C1, and determines the type of medium as a thick paper sheet. When, for example, the type of medium registered with the sheet feeding trays TR1 to TR4 is an ordinary paper sheet, and the determination result of the bend determiner C1 is a large bend, the medium type determiner C2 determines that the type of medium is consistent. In this case, the medium type determiner C2 according to the first example preferentially uses the type of medium registered with the sheet feeding trays TR1 to TR4.

A fixing control member C3 includes a heating control member C3a, and controls the fixing device F. To form an image, the fixing control member C3 controls the transport speed, the fixing temperature, and the fixing pressure in accordance with the type of medium based on the determination result of the medium type determiner C2.

The heating control member C3a controls a heater 31, serving as an example of a heater, installed in the heating roller Fh. The heating control member C3a controls turning on or off of the heater 31 to bring the temperature of the fixing area Q5 to a fixing temperature corresponding to the type of medium. In the first example, the fixing temperature is set or controlled to be higher when the degree of bending is small, that is, when the type of medium is, for example, a thick paper sheet, than when the degree of bending is large.

The heating control member C3a basically controls the heater 31 at a fixing temperature corresponding to the type of medium set at the medium type determiner C2 based on, for example, the registration information of the sheet feeding trays TR1 to TR4. When the medium type determiner C2 determines that the type of medium is inconsistent, the heating control member C3a controls the heater 31 at the fixing temperature corresponding to the type of medium based on the detection result of the loop sensor 21-28. More specifically, the heating control member C3a controls the heater 31 based on the bend of the medium detected by the loop sensor 21-28.

When the medium type determiner C2 determines that the type of medium is inconsistent, the heating control member C3a controls the heater 31 by switching the fixing temperature while the recording paper sheet S is passing the fixing area Q5. In the first example, when the recording paper sheet S comes into contact with the surface of the heating roller Fh heated by the heater 31, the recording paper sheet S undergoes fixing with the heat of the heating roller Fh. Thus, the temperature of the contact surface of the heating roller Fh that comes into contact with the recording paper sheet S falls. When the setting of the fixing temperature does not conform with the type of medium, the temperature during a second rotation may be excessively low or high. The heating roller Fh in a commercially available typical copying machine has a circumference of approximately 70 to 90 mm (diameter of 24 to 30 mm). As described above, bend detection is performed at a portion 10 to 20 mm from the leading end of the recording paper sheet S. Thus, in the first example, a bend of the recording paper sheet S is detected while the heating roller Fh makes one rotation after the leading end of the recording paper sheet S arrives at the fixing area Q5. The heating roller Fh has a circumference of 70 to 90 mm. Thus, regardless of when the fixing temperature is switched to the fixing temperature conforming with the type of medium after a bend is detected at a portion 10 to 20 mm from the leading end of the recording paper sheet S, the switching is finished fully before the start of a second rotation.

### (Operation According to First Example)

In the copying machine U according to the first example with the above structure, a bend of the recording paper sheet S that has passed the second transfer area Q4 at the time when the leading end of the recording paper sheet S arrives at the fixing area Q5 is detected by the loop sensor 21-28. Based on the detection result of the loop sensor 21-28, the type of the recording paper sheet S is determined, and the fixing temperature is controlled.

The technologies of determining the type of medium with reflection light described in Japanese Unexamined Patent Application Publication Nos. 2019-12174 and 2019-184778 involve the use of an expensive sensor. In addition, when, for example, colored or coated paper sheets are used, these technologies are more likely to cause detection errors, and have low detection accuracy. In addition, these technologies involves no contact, and thus have low reliability.

In contrast, the loop sensor 21-28 according to the first example is capable of determining the type of medium with a simple structure including the rotating actuator 21 and a sensor portion 27+28 that detects only passage or shielding of light. The actuator 21 comes into contact with the recording paper sheet S for detection, and is thus capable of performing detection on, for example, a colored paper sheet further accurately and reliably than existing technologies.

In the apparatus described in Japanese Unexamined Patent Application Publication No. 2007-199343, a recording medium hits against the roller when entering the nip for fixing the recording medium, and thus the transport speed is rapidly changed, and takes some time to be settled. This may take time for the apparatus to determine the type of recording medium. Thus, as described in Japanese Unexamined Patent Application Publication No. 2007-199343, this structure is to form an image on a second recording medium and the subsequent recording media without forming an image on a first recording medium.

In contrast, the first example determines the type based on a bend of the recording paper sheet S, and thus is capable of performing detection more speedily than the apparatus in Japanese Unexamined Patent Application Publication No. 2007-199343. In addition, the first example is capable of determining or presuming the type of medium while the heating roller Fh makes one rotation. Thus, the first example is capable of determining the type of medium in a first rotation of the heating roller Fh in which the fixing temperature is less likely to fall, and capable of controlling the fixing temperature before the heating roller Fh starts making a second rotation. Thus, despite in the image forming operation to form an image on multiple recording paper sheets S, the image forming operation involves fewer fixing errors on the recording paper sheets S from the first recording paper sheet S.

In the image forming operation to form an image on multiple recording paper sheets S, the copying machine U according to the first example detects a bend of a first recording paper sheet S and presumes the type of medium, and the detection result of the first recording paper sheet S is used for the subsequent sheets (second and following sheets). Thus, a detection process and a determination process that are highly unlikely to be used are reduced, and the processing load is thus reduced.

Particularly, the copying machine U according to the first example detects a small degree of bending and a large degree of bending with the actuator 21 that comes into contact with the recording paper sheet S. Thus, the copying machine U is capable of more reliably detecting the difference in the degree of bending with a method involving a contact process than a contactless detection method.

For the recording paper sheet S with a small degree of bending, a fixing temperature is set higher than for the recording paper sheet S with a large degree of bending, and fixing errors resulting from the deficiency of the fixing temperature for, for example, a thick paper sheet are reduced.

In the copying machine U according to the first example, the post-transfer guide 2 guides the recording paper sheet S in a direction away from the imaginary line 4, and then the inlet chute 3 guides the recording paper sheet S in a direction toward the imaginary line 4. Thus, the paper sheet guide 1 including the post-transfer guide 2 and the inlet chute 3 facilitates bending of the recording paper sheet S. Thus, the copying machine U facilitates determination of the degree of bending compared to the paper sheet guide 1 that does not facilitate bending.

### MODIFICATION EXAMPLES

Although an exemplary embodiment of the present disclosure has been described in detail above, the present disclosure is not limited to the exemplary embodiment, and may be modified in various manners within the scope of the gist of the present disclosure described in the scope of claims. Modification examples (H01) to (H06) of the present disclosure are described below.
(H01) As the image forming apparatus according to the exemplary embodiment, a copying machine U has been described, but the present disclosure is not limited to this. For example, the copying machine U may be formed from a printer, a fax machine, or a multifunction machine having multiple or all the functions of these.
(H02) The apparatus according to the exemplary embodiment employing four-color developers is described as an example of the copying machine U, but the present disclosure is not limited to this. For example, the copying machine U is also applicable to a single-color image forming apparatus or a multi-color image forming apparatus using three or less colors or five or more colors. A structure including the intermediate transfer belt B is described as an example of the copying machine U, but the present disclosure is not limited to this. For example, the copying machine U is also applicable to, for example, a structure that performs direct transfer from a photoconductor to the recording paper sheet S.
(H03) The apparatus according to the exemplary embodiment detects a small degree of bending and a large degree of bending in two steps, but the present disclosure is not limited to this. Instead, an apparatus may additionally include a shield and a sensor portion to be capable of performing determination in three or more steps.
(H04) In the apparatus according to the exemplary embodiment, preferably, the post-transfer guide 2 and the inlet chute 3 have shapes to facilitate bending, as illustrated in the exemplary embodiment, but the present disclosure is not limited to this. The shapes are changeable as appropriate in accordance with, for example, the design or the specifications of the transport path for the recording paper sheet S.
(H05) The apparatus according to the exemplary embodiment is capable of controlling the fixing temperature for the recording paper sheets S from the first recording paper sheet S. Instead, the apparatus may simply determine the type of medium without forming an image on a first recording paper sheet, and may form the image on second and following recording paper sheets.
(H06) The apparatus according to the exemplary embodiment presumes the type of the recording paper sheet S for each image forming operation (job), but the present disclosure is not limited to this. The apparatus may store the most recent presumption results of the paper sheets fed from the multiple sheet feeding trays TR1 to TR4 as paper sheet settings for each of the sheet feeding trays TR1 to TR4, and may preliminarily read the settings in the subsequent job. The apparatus with this mechanism is capable of performing further stable control.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

An image forming apparatus, comprising:
a fixing member that includes a heater that generates heat in accordance with a predetermined fixing temperature to fix an unfixed image held on a medium;
a bend detector that is disposed upstream from the fixing member in a medium transport direction to detect a bend of a medium having a leading end arriving at the fixing member; and
a heating control member that controls the heater based on the bend of the medium detected by the bend detector.
   (((2)))

The image forming apparatus according to (((1))),
wherein the bend detector includes:
   a contact portion that comes into contact with a medium;
   a small bend detection portion that detects that a degree of bending of the medium arrives at a predetermined small degree of bending; and
   a large bend detection portion that detects that the degree of bending of the medium arrives at a large degree of bending larger than the small degree of bending.
      (((3)))

The image forming apparatus according to (((2))),
wherein the heating control member controls the heater to raise the fixing temperature when the degree of bending is smaller than the large degree of bending.
   (((4)))

The image forming apparatus according to any one of (((1))) to (((3))), comprising:
a transporting member that is disposed upstream from the fixing member in the medium transport direction to transport the medium toward the fixing member; and
a guide member that is disposed between the fixing member and the transporting member in the medium transport direction to guide the medium toward an inlet of the fixing member, the guide member including a first guide portion and a second guide portion, the first guide portion being capable of guiding the medium in a direction away from an imaginary line connecting the inlet of the fixing member and the transporting member, the second guide portion being disposed downstream from the first guide portion in the medium transport direction and being capable of guiding the medium in a direction toward the imaginary line and toward the inlet of the fixing member.
   (((5)))

The image forming apparatus according to any one of (((1))) to (((4))),
wherein the fixing member rotates in accordance with transportation of the medium,
wherein the bend detector detects a bend of the medium while the fixing member makes one rotation after a leading end of the medium arrives at the fixing member, and
wherein the heating control member controls the heater after the bend detector detects a bend in the medium and while the medium having the bend detected passes the fixing member.
   (((6)))

The image forming apparatus according to (((5))),
wherein, in an operation to form an image on a plurality of media, the image forming apparatus detects a bend of a first one of the media using the bend detector, and uses a detection result of the bend of the first medium for subsequent one or more of the media.

What is claimed is:

1. An image forming apparatus, comprising:
a fixing member that includes a heater that generates heat in accordance with a predetermined fixing temperature to fix an unfixed image held on a medium;
a bend detector that is disposed upstream from the fixing member in a medium transport direction to detect a bend of a medium having a leading end arriving at the fixing member; and
a heating control member that controls the heater based on the bend of the medium detected by the bend detector.

2. The image forming apparatus according to claim 1,
wherein the bend detector includes:
a contact portion that comes into contact with a medium;
a small bend detection portion that detects that a degree of bending of the medium arrives at a predetermined small degree of bending; and
a large bend detection portion that detects that the degree of bending of the medium arrives at a large degree of bending larger than the small degree of bending.

3. The image forming apparatus according to claim 2,
wherein the heating control member controls the heater to raise the fixing temperature when the degree of bending is smaller than the large degree of bending.

4. The image forming apparatus according to claim 1, comprising:
a transporting member that is disposed upstream from the fixing member in the medium transport direction to transport the medium toward the fixing member; and
a guide member that is disposed between the fixing member and the transporting member in the medium transport direction to guide the medium toward an inlet of the fixing member, the guide member including a first guide portion and a second guide portion, the first guide portion being capable of guiding the medium in a direction away from an imaginary line connecting the inlet of the fixing member and the transporting member, the second guide portion being disposed downstream from the first guide portion in the medium transport direction and being capable of guiding the medium in a direction toward the imaginary line and toward the inlet of the fixing member.

5. The image forming apparatus according to claim 1,
wherein the fixing member rotates in accordance with transportation of the medium,
wherein the bend detector detects a bend of the medium while the fixing member makes one rotation after a leading end of the medium arrives at the fixing member, and
wherein the heating control member controls the heater after the bend detector detects a bend in the medium and while the medium having the bend detected passes the fixing member.

6. The image forming apparatus according to claim 5,
wherein, in an operation to form an image on a plurality of media, the image forming apparatus detects a bend of a first one of the media using the bend detector, and uses a detection result of the bend of the first medium for subsequent one or more of the media.

7. An image forming apparatus, comprising:
fixing means including a heater that generates heat in accordance with a predetermined fixing temperature to fix an unfixed image held on a medium;
bend detecting means, disposed upstream from the fixing means in a medium transport direction, for detecting a bend of a medium having a leading end arriving at the fixing means; and
heating control means for controlling the heater based on the bend of the medium detected by the bend detecting member.
